(19) United States
(12) Patent Application Publication
(10) Pub. No.: US 2024/0172209 A1
(43) Pub. Date: May 23, 2024

(54) METHOD AND DEVICE IN NODES USED FOR WIRELESS COMMUNICATION

(71) Applicants: Lin YANG, Shanghai (CN); Ping WANG, Shanghai (CN); Xiaobo ZHANG, Shanghai (CN)

(72) Inventors: Lin YANG, Shanghai (CN); Ping WANG, Shanghai (CN); Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/513,647

(22) Filed: Nov. 20, 2023

(30) Foreign Application Priority Data
Nov. 22, 2022 (CN) 202211467978.X

(51) Int. Cl. H04W 72/0457; H04L 5/14; H04W 72/231; H04W 72/30

(52) U.S. Cl. CPC H04W 72/0457; H04L 5/1469; H04W 72/231; H04W 72/30

(57) ABSTRACT

Present application discloses a method and a device in a node for wireless communications. A first node maintains a first timer; and as a response to expiration of the first timer, starts to monitor a PDCCH on at least second BWP; herein, a first BWP is an active BWP, the first timer depending on the first BWP, while the second BWP is a BWP on a first serving cell other than a default BWP, where the first BWP is on the first serving cell; the action of maintaining a first timer includes: as a response to any condition in a first condition set being satisfied, starting or restarting the first timer; the first condition set includes receiving a PDCCH on the first BWP, the PDCCH being used for a Downlink assignment or Uplink Grant and identified by a first identifier; this method and device can enhance the transmission reliability.

### CROSS REFERENCE TO RELATED APPLICATIONS

This application claims the priority benefit of Chinese Patent Application No. 202211467978.X, filed on Nov. 22, 2022, the full disclosure of which is incorporated herein by reference.

### BACKGROUND

### Technical Field

The present application relates to transmission methods and devices in wireless communication systems, and in particular to a method and device for radio signal transmission in a wireless communication system supporting cellular networks.

### Related Art

Application scenarios of future wireless communication systems are becoming increasingly diversified, and different application scenarios have different performance demands on systems. In order to meet different performance requirements of various application scenarios, the 3rd Generation Partner Project (3GPP) Radio Access Network (RAN) #72 plenary decided to conduct the study of New Radio (NR), or what is called fifth Generation (5G). The Work Item (WI) of NR was approved at the 3GPP RAN #75 plenary to standardize the NR.

At present, new studies of 5G NR have begun in R18, with network energy saving being one of its Study Items (SI), where the adaptation of spatial elements of a base station, such as antenna element, antenna panel, antenna port, logical antenna port, Transmit Radio Unit (TxRU) and Transmission Reception Point (TRxP), is seen as a research direction of energy saving.

### SUMMARY

Inventors find through researches that BWP switching is a key issue in a scenario that requires energy saving.

To address the above problem, the present application provides a solution. It should be noted that although originally targeted at energy-saving scenarios, this present application can also be applied to other scenarios that are not energy-saving. In addition, the adoption of a unified design scheme for various scenarios, including but not limited to energy-saving and non-energy-saving ones, contributes to the reduction of hardcore complexity and costs. It should be noted that if no conflict is incurred, embodiments in any node in the present application and the characteristics of the embodiments are also applicable to any other node, and vice versa. What's more, the embodiments in the present application and the characteristics in the embodiments can be arbitrarily combined if there is no conflict.

In one embodiment, interpretations of the terminology in the present application refer to definitions given in the 3GPP TS36 series.

In one embodiment, interpretations of the terminology in the present application refer to definitions given in the 3GPP TS38 series.

In one embodiment, interpretations of the terminology in the present application refer to definitions given in the 3GPP TS37 series.

In one embodiment, interpretations of the terminology in the present application refer to definitions given in Institute of Electrical and Electronics Engineers (IEEE) protocol specifications.

The present application provides a method in a first node for wireless communications, comprising:
maintaining a first timer; and as a response to expiration of the first timer, starting to monitor a PDCCH on at least second Bandwidth Part (BWP);
herein, a first BWP is an active BWP, the first timer depending on the first BWP; while the second BWP is a BWP on a first serving cell other than a default BWP, where the first BWP and the second BWP are both on the first serving cell; the action of maintaining a first timer comprises: as a response to any condition in a first condition set being satisfied, starting or restarting the first timer; the first condition set includes receiving a PDCCH on the first BWP, the PDCCH being used for a Downlink assignment or Uplink Grant, and the PDCCH being identified by a first identifier; the default BWP on the first serving cell is indicated by a defaultDownlinkBWP-Id or an initialDownlinkBWP.

In one embodiment, an advantage of the above method includes: enhancing the reliability of downlink transmission.

In one embodiment, an advantage of the above method includes: optimizing the design of BWP switching while guaranteeing the system's compatibility.

According to one aspect of the present application, the first node comprises a UE.

According to one aspect of the present application, the first node comprises a relay node.

According to one aspect of the present application, the above method is characterized in comprising: the first BWP being the default BWP on the first serving cell.

In one embodiment, an advantage of the above method includes: increasing the flexibility of scheduling.

According to one aspect of the present application, the above method is characterized in that the at least second BWP includes/include the default BWP on the first serving cell.

According to one aspect of the present application, the above method is characterized in comprising:
monitoring a PDCCH on a BWP of the at least second BWP, and as a response to receiving the PDCCH, stopping monitoring a PDCCH on any BWP of the at least second BWP other than the BWP.

According to one aspect of the present application, the above method is characterized in comprising:
receiving a first message;
herein, the first message is used for configuring the second BWP.

According to one aspect of the present application, the above method is characterized in that the first node has a missed detection of a first signaling, the first signaling indicating the second BWP, the first signaling being non-UE dedicated.

The present application provides a first node for wireless communications, comprising:
a first processor, maintaining a first timer; and as a response to expiration of the first timer, starting to monitor a PDCCH on at least second Bandwidth Part (BWP);
herein, a first BWP is an active BWP, the first timer depending on the first BWP; while the second BWP is a BWP on a first serving cell other than a default BWP, where the first BWP and the second BWP are both on the first serving cell; the action of maintaining a first timer comprises: as a response to any condition in a first condition set being satisfied, starting or restarting the first timer; the first condition set includes receiving a PDCCH on the first BWP, the PDCCH being used for a Downlink assignment or Uplink Grant, and the PDCCH being identified by a first identifier; the default BWP on the first serving cell is indicated by a defaultDownlinkBWP-Id or an initialDownlinkBWP.

In one embodiment, compared with the prior art, the present application is advantageous in the following aspects:
increasing the flexibility of scheduling.
enhancing the reliability of downlink transmission.
optimizing the design of BWP switching while guaranteeing good compatibility.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of a first timer and second BWP according to one embodiment of the present application.

FIG. 2 illustrates a schematic diagram of a network architecture according to one embodiment of the present application.

FIG. 3 illustrates a schematic diagram of a radio protocol architecture of a user plane and a control plane according to one embodiment of the present application.

FIG. 4 illustrates a schematic diagram of a first communication device and a second communication device according to one embodiment of the present application.

FIG. 5 illustrates a flowchart of transmission between a first node and a second node according to one embodiment of the present application.

FIG. 6 illustrates a schematic diagram of a relation between first BWP and default BWP of a first serving cell according to one embodiment of the present application.

FIG. 7 illustrates a schematic diagram of a relation between at least second BWP and default BWP of a first serving cell according to one embodiment of the present application.

FIG. 8 illustrates a schematic diagram of a first signaling being used to determine second BWP according to one embodiment of the present application.

FIG. 9 illustrates a structure block diagram of a processing device used in a first node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

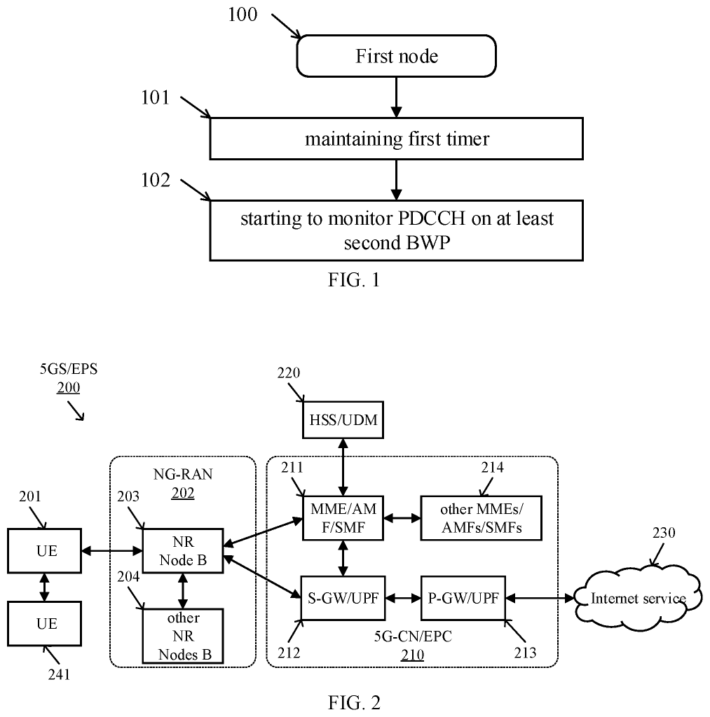

Embodiment 1 illustrates a flowchart of a first timer and second BWP according to one embodiment of the present application, as shown in FIG. 1. In FIG. 1, each box represents a step. Particularly, the sequential step arrangement in each box herein does not imply a chronological order of steps marked respectively by these boxes.

A first node 100 maintains a first timer in step 101; and in step 102, as a response to expiration of the first timer, starts to monitor a PDCCH on at least second Bandwidth Part (BWP);

In Embodiment 1, a first BWP is an active BWP, the first timer depending on the first BWP, while the second BWP is a BWP on a first serving cell other than a default BWP, where the first BWP and the second BWP are both on the first serving cell; the action of maintaining a first timer comprises: as a response to any condition in a first condition set being satisfied, starting or restarting the first timer; the first condition set includes receiving a PDCCH on the first BWP, the PDCCH being used for a Downlink assignment or Uplink Grant, and the PDCCH being identified by a first identifier; the default BWP on the first serving cell is indicated by a defaultDownlinkBWP-Id or an initialDownlinkBWP.

In one embodiment, the BWP refers to Bandwidth part.

In one embodiment, the PDCCH refers to Physical downlink control channel.

In one embodiment, the first node 100 is the first node in the present application.

In one embodiment, the first timer is a higher layer timer.

In one embodiment, the first timer is a Radio Resource Control (RRC) layer timer.

In one embodiment, the first timer's name includes timer.

In one embodiment, the first timer's name includes bwp.

In one embodiment, the first timer's name includes Inactivity.

In one embodiment, the first timer's name includes bwp-InactivityTimer.

In one embodiment, the first timer is a bwp-InactivityTimer.

In one embodiment, the expiration value of the first timer is configured by RRC signaling.

In one embodiment, the expiration value of the first timer is configurable.

In one embodiment, the expiration value of the first timer is pre-configured.

In one embodiment, the expiration value of the first timer is of a fixed size.

In one embodiment, the expiration value of the first timer comprises a positive integer number of millisecond(s) (ms).

In one embodiment, the expiration value of the first timer comprises at least 2 ms.

In one embodiment, the expiration value of the first timer comprises Kms.

In one subembodiment, K is one of 2, 3, 4, 5, 6, 8, 10, 20, 30, 40, 50, 60, 80, 100, 200, 300, 500, 750, 1280, 1920, or 2560.

In one subembodiment, K is a positive integer other than 2, 3, 4, 5, 6, 8, 10, 20, 30, 40, 50, 60, 80, 100, 200, 300, 500, 750, 1280, 1920, and 2560.

In one embodiment, a duration of a first timer is not updated until the first timer is stopped.

In one embodiment, a duration of a first timer is not updated until the first timer expires.

In one embodiment, a duration of a first timer is not updated until the first timer is stopped or expired.

In one embodiment, a first timer keeps running since its start till the first timer is stopped.

In one embodiment, a first timer keeps running since its start till the first timer expires.

In one embodiment, a first timer keeps running since its start till the first timer is stopped or expired.

In one embodiment, the phrase of starting or restarting the first timer includes a meaning that: the first timer starts running.

In one embodiment, the phrase of starting or restarting the first timer includes a meaning that: the first timer starts running from an initial value.

In one embodiment, the phrase of starting or restarting the first timer includes a meaning that: the first timer starts running from 0.

In one embodiment, the phrase of starting or restarting the first timer includes a meaning that: the first timer is not running, and the first timer starts to run.

In one embodiment, the phrase of starting or restarting the first timer includes a meaning that: the first timer is not running, and the first timer starts to run from an initial value.

In one embodiment, the phrase of starting or restarting the first timer includes a meaning that: the first timer is not running, and the first timer starts to run from 0.

In one embodiment, the phrase of starting or restarting the first timer includes a meaning that: the first timer restarts running.

In one embodiment, the phrase of starting or restarting the first timer includes a meaning that: the first timer restarts running from an initial value.

In one embodiment, the phrase of starting or restarting the first timer includes a meaning that: the first timer restarts running from 0.

In one embodiment, the phrase of starting or restarting the first timer includes a meaning that: the first timer is running, and the first timer restarts to run.

In one embodiment, the phrase of starting or restarting the first timer includes a meaning that: the first timer is running, and the first timer restarts to run from an initial value.

In one embodiment, the phrase of starting or restarting the first timer includes a meaning that: the first timer is running, and the first timer restarts to run from 0.

In one embodiment, as a response to expiration of the first timer, the first node 100 starts to monitor a PDCCH on the at least second BWP.

In one embodiment, the meaning of the statement that as a response to expiration of the first timer, the action includes: the action upon expiration of the first timer.

In one embodiment, the meaning of the statement that as a response to expiration of the first timer, the action includes: expiration of the first timer being used to determine the action.

In one embodiment, the meaning of the statement that as a response to expiration of the first timer, the action includes: expiration of the first timer being a triggering condition for the action.

In one embodiment, as a response to expiration of the first timer, the first node 100 stops monitoring a PDCCH on the first BWP.

In one embodiment, as a response to expiration of the first timer, the first node 100 stops monitoring a PDCCH on the first BWP and starts to monitor a PDCCH on the at least second BWP.

In one embodiment, as a response to expiration of the first timer, the first node 100 stops monitoring a PDCCH on the first BWP and starts to monitor a PDCCH on the second BWP.

In one embodiment, as a response to expiration of the first timer, the first node 100 stops monitoring a PDCCH on the first BWP and starts to monitor a PDCCH on a BWP on the first serving cell other than the second BWP.

In one embodiment, the meaning of the sentence of starting to monitor a PDCCH on at least second BWP includes: resuming PDCCH monitoring according to a Search space set on the at least second BWP.

In one embodiment, the meaning of the sentence of starting to monitor a PDCCH on at least second BWP includes: monitoring a PDCCH on a search space set with a group index 0 on the at least second BWP.

In one embodiment, the meaning of the sentence of starting to monitor a PDCCH on at least second BWP includes: resuming PDCCH monitoring according to a Search space set on the second BWP.

In one embodiment, the meaning of the sentence of starting to monitor a PDCCH on at least second BWP includes: monitoring a PDCCH on a search space set with a group index 0 on the second BWP.

In one embodiment, the meaning of the sentence of starting to monitor a PDCCH on at least second BWP includes: resuming PDCCH monitoring according to a Search space set on a BWP on the first serving cell other than the second BWP.

In one embodiment, the meaning of the sentence of starting to monitor a PDCCH on at least second BWP includes: monitoring a PDCCH on a search space set with a group index 0 on a BWP on the first serving cell other than the second BWP.

In one embodiment, the meaning of the sentence of starting to monitor a PDCCH on at least second BWP includes: resuming PDCCH monitoring according to a Search space set on the second BWP, or, resuming PDCCH monitoring according to a Search space set on a BWP on the first serving cell other than the second BWP.

In one embodiment, the meaning of the sentence of starting to monitor a PDCCH on at least second BWP includes: resuming PDCCH monitoring according to a Search space set on the second BWP, or, monitoring a PDCCH according to a search space set with a group index 0 on a BWP on the first serving cell other than the second BWP.

In one embodiment, the meaning of the sentence of starting to monitor a PDCCH on at least second BWP includes: monitoring a PDCCH according to a search space set with a group index 0 on the second BWP, or, resuming PDCCH monitoring according to a Search space set on a BWP on the first serving cell other than the second BWP.

In one embodiment, the meaning of the sentence of starting to monitor a PDCCH on at least second BWP includes: monitoring a PDCCH according to a search space set with a group index 0 on the second BWP, or, monitoring a PDCCH according to a search space set with a group index 0 on a BWP on the first serving cell other than the second BWP.

In one embodiment, the meaning of the monitoring includes to detect.

In one embodiment, the meaning of the monitoring includes to receive.

In one embodiment, the meaning of the monitoring includes to search.

In one embodiment, the meaning of the monitoring includes to monitor.

In one embodiment, the meaning of the monitoring includes to check by means of Cyclic Redundancy Check (CRC).

In one embodiment, the action of monitoring a PDCCH includes determining the presence of the PDCCH by energy monitoring.

In one embodiment, the action of monitoring a PDCCH includes determining the presence of the PDCCH by coherent detection.

In one embodiment, the action of monitoring a PDCCH includes determining the presence of the PDCCH by wideband detection.

In one embodiment, the action of monitoring a PDCCH includes determining the presence of the PDCCH by correlation detection.

In one embodiment, the action of monitoring a PDCCH includes determining the presence of the PDCCH by synchronous detection.

In one embodiment, the action of monitoring a PDCCH includes determining the presence of the PDCCH by waveform detection.

In one embodiment, the action of monitoring a PDCCH includes determining the presence of the PDCCH by maximum likelihood detection.

In one embodiment, the meaning of the action of monitoring a PDCCH includes: monitoring a DCI format transmitted in the PDCCH.

In one embodiment, the meaning of the action of monitoring a PDCCH includes: monitoring a PDCCH candidate to determine whether the PDCCH is transmitted.

In one embodiment, the meaning of the phrase of monitoring a PDCCH includes: monitoring a PDCCH candidate to determine whether the PDCCH is transmitted in a PDCCH candidate.

In one embodiment, the meaning of the action of monitoring a PDCCH includes: monitoring a PDCCH candidate to determine whether a DCI format is detected in a PDCCH candidate.

In one embodiment, the meaning of the action of monitoring a PDCCH includes: monitoring a PDCCH candidate to determine whether a DCI format is detected in a PDCCH candidate to be transmitted in the PDCCH.

In one embodiment, the monitoring refers to blind decoding, the action of monitoring a PDCCH meaning: performing decoding operation; if it is determined that decoding is correct according to CRC, it is then determined that a DCI format is detected to be transmitted in the PDCCH; otherwise, it is determined that no DCI format is detected.

In one embodiment, the monitoring refers to blind decoding, the action of monitoring a PDCCH meaning: performing decoding operation in a PDCCH candidate; if it is determined that decoding is correct in a PDCCH candidate according to CRC, it is then determined that a DCI format is detected in the PDCCH candidate to be transmitted in the PDCCH; otherwise, it is determined that no DCI format is detected in the PDCCH candidate.

In one embodiment, the monitoring refers to coherent detection, the action of monitoring a PDCCH meaning: performing coherent reception and measuring energy of a signal obtained by the coherent reception; if the energy of the signal obtained by the coherent reception is larger than a first given threshold, it is determined that a DCI format is detected to be transmitted in the PDCCH; otherwise, it is determined that no DCI format is detected.

In one embodiment, the monitoring refers to energy detection, the action of monitoring a PDCCH meaning: sensing energy of radio signals and averaging to obtain a received energy; if the received energy is larger than a second given threshold, it is determined that a DCI format is detected to be transmitted in the PDCCH; otherwise, it is determined that no DCI format is detected.

In one embodiment, the first node 100 is configured with multiple BWPs.

In one embodiment, the first BWP is an active Downlink (DL) BWP.

In one embodiment, the first BWP is configured by UE-dedicated signaling.

In one embodiment, the first BWP is configured by non-UE-dedicated signaling.

In one embodiment, the first BWP is configured per serving cell.

In one embodiment, the first BWP is a BWP on the first serving cell other than the default BWP.

In one embodiment, a “BWP-Id” of the first BWP is unequal to the defaultDownlinkBWP-Id.

In one embodiment, a “BWP-Id” of the first BWP is unequal to 0.

In one embodiment, a “BWP-Id” of the first BWP is equal to the defaultDownlinkBWP-Id.

In one embodiment, a “BWP-Id” of the first BWP is equal to 0.

In one embodiment, the first BWP is a BWP on the first serving cell other than the default BWP and an initial BWP.

In one embodiment, the first BWP is an Initial BWP.

In one embodiment, the first BWP is a Default BWP.

In one embodiment, the first BWP comprises a positive integral multiple of 12 subcarriers.

In one embodiment, the first BWP comprises a positive integral multiple of 12 consecutive subcarriers.

In one embodiment, the first BWP comprises a positive integer number of Common Resource Block(s) (CRB(s)).

In one embodiment, the second BWP is a DL BWP.

In one embodiment, the second BWP is configured by non-UE-dedicated signaling.

In one embodiment, the second BWP is configured by Cell-specific signaling.

In one embodiment, the second BWP is configured by UE group-common signaling.

In one embodiment, the second BWP is configured per serving cell.

In one embodiment, the at least second BWP includes/include the second BWP.

In one embodiment, the at least second BWP includes/include a BWP other than the second BWP.

In one embodiment, the at least second BWP includes/include only the second BWP.

In one embodiment, the at least second BWP includes/include the default BWP on the first serving cell.

In one embodiment, the first BWP and the second BWP have different BWP-Ids.

In one embodiment, the second BWP comprises a positive integral multiple of 12 subcarriers.

In one embodiment, the second BWP comprises a positive integral multiple of 12 consecutive subcarriers.

In one embodiment, the second BWP comprises a positive integer number of CRBs.

In one embodiment, a bandwidth of the second BWP is smaller than that of the first BWP.

In one embodiment, the first BWP comprises N1 subcarriers, while the second BWP comprises N2 subcarriers, where N1 and N2 are positive integral multiples of 12, respectively, N1 being greater than N2.

In one embodiment, the first BWP comprises K1 CRBs, while the second BWP comprises K2 CRBs, where K1 and K2 are positive integers, respectively, K1 being greater than K2.

In one embodiment, the first serving cell comprises a Special Cell (SpCell).

In one subembodiment, the SpCell comprises a Primary Cell (PCell).

In one subembodiment, the SpCell comprises a Primary secondary cell (PSCell).

In one embodiment, the first serving cell comprises a Secondary cell (SCell).

In one embodiment, the first serving cell belongs to a Master cell group (MCG).

In one embodiment, the first serving cell belongs to a Secondary cell group (SCG).

In one embodiment, the first serving cell is Self-scheduled.

In one embodiment, the first serving cell is Cross carrier scheduled.

In one embodiment, the first identifier is a Radio Network Temporary Identity (RNTI).

In one embodiment, the first identifier is a Cell-RNTI (C-RNTI).

In one embodiment, the first identifier is a Configured Scheduling-RNTI (CS-RNTI).

In one embodiment, the first identifier is one of a C-RNTI or a CS-RNTI.

In one embodiment, the first identifier is an RNTI other than a C-RNTI and a CS-RNTI.

In one embodiment, the first identifier is an index value.

In one embodiment, the first identifier is a non-negative integer.

In one embodiment, the first identifier is a positive integer.

In one embodiment, the first identifier is an integer.

In one embodiment, the first identifier is an integer on a decimal base.

In one embodiment, the first identifier is an integer on a hexadecimal base.

In one embodiment, the first identifier is configured by a transmitter of the PDCCH.

In one embodiment, the first identifier is configured by RRC signaling.

In one embodiment, the first identifier is configured by a Medium access control (MAC) Control element (CE).

In one embodiment, the first identifier is configured by a Multicell/Multicast Coordination Entity (MCE).

In one embodiment, the first identifier is an identifier of a UE group.

In one embodiment, the sentence that the PDCCH being identified by a first identifier includes a meaning that: the PDCCH carries the first identifier.

In one embodiment, the sentence that the PDCCH being identified by a first identifier includes a meaning that: the first identifier is used for scrambling of bits output by a Downlink control information (DCI) carried by the PDCCH through channel coding.

In one embodiment, the sentence that the PDCCH being identified by a first identifier includes a meaning that: the first identifier is used for a Scrambling sequence generator of bits output by a DCI carried by the PDCCH through channel coding.

In one embodiment, the sentence that the PDCCH being identified by a first identifier includes a meaning that: a CRC of the PDCCH is scrambled by the first identifier.

In one embodiment, the sentence that the PDCCH being identified by a first identifier includes a meaning that: the first identifier is used for scrambling of a CRC bit carried in the PDCCH.

In one embodiment, the sentence that the PDCCH being identified by a first identifier includes a meaning that: a CRC bit of a DCI carried by the PDCCH carries the first identifier.

In one embodiment, the sentence that the PDCCH being identified by a first identifier includes a meaning that: a channel or signal scheduled by a DCI carried by the PDCCH carries the first identifier.

In one embodiment, the sentence that the PDCCH being identified by a first identifier includes a meaning that: the first identifier is used for generating a Scrambling sequence of a channel or signal scheduled by a DCI carried by the PDCCH.

In one embodiment, the sentence that the PDCCH being identified by a first identifier includes a meaning that: the first identifier is used for initializing a scrambling generator of a channel or signal scheduled by a DCI carried by the PDCCH.

In one embodiment, the sentence that the PDCCH being identified by a first identifier includes a meaning that: one or more fields comprised by a DCI carried by the PDCCH explicitly indicate the first identifier.

In one embodiment, the sentence that the PDCCH being identified by a first identifier includes a meaning that: the PDCCH is used by the first node in the present application to determine the first identifier.

In one embodiment, the first condition set comprises: receiving a PDCCH on the first BWP, the PDCCH being used for a downlink assignment or an uplink assignment, the PDCCH being identified by a first identifier.

In one embodiment, the first condition set comprises: receiving a MAC Protocol data unit (PDU) in a configured downlink assignment used for unicast or Multicast/Broadcast Service (MBS) multicast.

In one embodiment, the first condition set comprises: Transmitting a MAC PDU in an uplink assignment, and not receiving an indication of Listen before talk (LBT) failure from lower layers.

In one subembodiment, the lower layers include a PHY.

In one subembodiment, the lower layers include a Layer 1 (L1).

In one embodiment, the first condition set comprises: receiving a PDCCH on the first BWP, the PDCCH being configured for multicast indicating downlink assignment, and being identified by a second identifier.

In one subembodiment, the second identifier is an RNTI.

In one subembodiment, the second identifier is a Group-RNTI (G-RNTI).

In one subembodiment, the second identifier is a G-CS-RNTI.

In one subembodiment, the second identifier is one of a G-RNTI or a G-CS-RNTI.

In one subembodiment, the second identifier is an RNTI other than a G-RNTI and a G-CS-RNTI.

In one subembodiment, the second identifier is an index value.

In one subembodiment, the second identifier is a non-negative integer.

In one subembodiment, the second identifier is a positive integer.

In one subembodiment, the second identifier is an integer.

In one subembodiment, the second identifier is an integer on a decimal base.

In one subembodiment, the second identifier is an integer on a hexadecimal base.

In one subembodiment, the second identifier is configured by a transmitter of the PDCCH.

In one subembodiment, the second identifier is configured by RRC signaling.

In one subembodiment, the second identifier is configured by a MAC CE.

In one subembodiment, the second identifier is configured by an MCE.

In one subembodiment, the second identifier is an identifier of a UE group.

In one embodiment, as a response to any condition in a first condition set being satisfied, start the first timer.

In one embodiment, as a response to any condition in a first condition set being satisfied, restart the first timer.

In one embodiment, as a response to any condition in a first condition set being satisfied, start the first timer when the first timer is not running.

In one embodiment, as a response to any condition in a first condition set being satisfied, restart the first timer when the first timer is running.

In one embodiment, when the action of maintaining a first timer is performed, there exists no ongoing Random access (RA) procedure that is associated with the first serving cell.

In one embodiment, the PDCCH is identified by the first identifier, the first identifier including a C-RNTI; as a response to receiving the PDCCH, an ongoing Random access (RA) procedure that is associated with the first serving cell is successfully completed.

In one embodiment, when the action of maintaining a first timer is performed, the first serving cell is an SCell, and the first BWP is not a dormant BWP on the first serving cell.

In one embodiment, when the action of maintaining a first timer is performed, the first serving cell is an SCell, and a BWP-Id of the first BWP is unequal to a dormantBWP-Id of the first serving cell.

In one embodiment, when the action of maintaining a first timer is performed, the first serving cell is an SCell, and the first BWP is not a BWP indicated by a dormantBWP-Id of the first serving cell.

In one embodiment, when the action of maintaining a first timer is performed, the first serving cell is an SCell, and a BWP-Id of the first BWP is unequal to a dormantBWP-Id of the first serving cell.

In one embodiment, the default BWP on the first serving cell is indicated by the defaultDownlinkBWP-Id.

In one embodiment, the default BWP on the first serving cell is indicated by the initialDownlinkBWP.

In one embodiment, the default BWP on the first serving cell is indicated by the defaultDownlinkBWP-Id or initialDownlinkBWP.

In one embodiment, a BWP-Id of the default BWP on the first serving cell is equal to the defaultDownlinkBWP-Id.

In one embodiment, a BWP-Id of the default BWP on the first serving cell is equal to 0.

In one embodiment, the default BWP on the first serving cell is an initial BWP.

In one embodiment, the sentence that the default BWP on the first serving cell is indicated by the defaultDownlinkBWP-Id or initialDownlinkBWP includes a meaning that: when the first node is configured with a defaultDownlinkBWP-Id for the first serving cell, the default BWP on the first serving cell is indicated by the defaultDownlinkBWP-Id.

In one embodiment, the sentence that the default BWP on the first serving cell is indicated by the defaultDownlinkBWP-Id or initialDownlinkBWP includes a meaning that: when the first node is configured without a defaultDownlinkBWP-Id for the first serving cell, the default BWP on the first serving cell is indicated by an initialDownlinkBWP.

In one embodiment, the sentence that the default BWP on the first serving cell is indicated by the defaultDownlinkBWP-Id or initialDownlinkBWP includes a meaning that: when the first node is configured with a defaultDownlinkBWP-Id for the first serving cell, a BWP-Id of the default BWP on the first serving cell is equal to the defaultDownlinkBWP-Id.

In one embodiment, the sentence that the default BWP on the first serving cell is indicated by the defaultDownlinkBWP-Id or initialDownlinkBWP includes a meaning that: when the first node is configured without a defaultDownlinkBWP-Id for the first serving cell, a “BWP-Id” of the default BWP on the first serving cell is equal to 0.

### Embodiment 2

Embodiment 2 illustrates a schematic diagram of a network architecture according to one embodiment of the present application, as shown in FIG. 2.

FIG. 2 is a diagram illustrating a network architecture of Long-Term Evolution (LTE), and Long-Term Evolution Advanced (LTE-A) and future 5G systems. The network architecture of LTE, LTE-A and future 5G systems are called an Evolved Packet System (EPS). The 5G NR or LTE network architecture can be called 5G System (5GS) /EPS 200 or some other applicable terms. The 5GS/EPS 200 may comprise one or more UEs 201, a UE 241 in Sidelink (SL) communication with the UE(s) 201, a Next Generation Radio Access Network (NG-RAN) 202, a 5G Core Network/Evolved Packet Core (5G-CN/EPC) 210, a Home Subscriber Server (HSS)/Unified Data Management (UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will find it easy to understand that various concepts presented throughout the present application can be extended to networks providing circuit switching services. The NG-RAN 202 comprises an NR node B (gNB) 203 and other gNBs 204. The gNB 203 provides UE 201-oriented user plane and control plane protocol terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the 5G-CN/EPC 210 for the UE 201. Examples of UE 201 include cellular phones, smart phones, Session Initiation Protocol (SIP) phones, laptop computers, Personal Digital Assistant (PDA), Satellite Radios, Global Positioning System (GPS), multimedia devices, video devices, digital audio players (for example, MP3 players), cameras, games consoles, unmanned aerial vehicles, air vehicles, narrow-band physical network equipment, machine-type communication equipment, land vehicles, automobiles, wearables, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected with the 5G-CN/EPC 210 via an S1/NG interface. The 5G-CN/EPC 210 comprises a Mobility Management Entity (MME)/Authentication Management Field (AMF)/Session Management Function (SMF) 211, other MMEs/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5G-CN/EPC 210. Generally, the MME/AMF/SMF 211 provides bearer and connection management. All user Internet Protocol (IP) packets are transmitted through the S-GW/UPF 212. The S-GW/UPF 212 is connected to the P-GW/UPF 213. The P-GW 213 provides UE IP address allocation and other functions. The P-GW/UPF 213 is connected to the Internet Service 230. The Internet Service 230 comprises operator-compatible IP services, specifically including Internet, Intranet, IP Multimedia Subsystem (IMS) and Packet Switching (PS) services.

In one embodiment, the first node in the present application includes the UE 201.

In one embodiment, the second node in the present application includes the gNB 203.

In one embodiment, a radio link between the UE 201 and the gNB 203 includes a cellular link.

In one embodiment, a transmitter of the first message includes the gNB 203.

In one embodiment, a receiver of the first message includes the UE 201.

In one embodiment, the gNB 203 supports energy saving techniques.

In one embodiment, the gNB 203 supports dynamic BWP switching.

In one embodiment, the gNB 203 supports non-UE dedicated BWP configuration.

In one embodiment, the gNB 203 supports non-UE dedicated BWP switching.

In one embodiment, the gNB 203 supports dynamic BWP switching.

In one embodiment, the UE 201 supports UE-dedicated BWP configuration.

In one embodiment, the UE 201 supports UE-dedicated BWP switching.

In one embodiment, the UE 201 supports non-UE dedicated BWP configuration.

In one embodiment, the UE 201 supports non-UE dedicated BWP switching.

In one embodiment, the UE 201 supports configurations of multiple BWPs.

### Embodiment 3

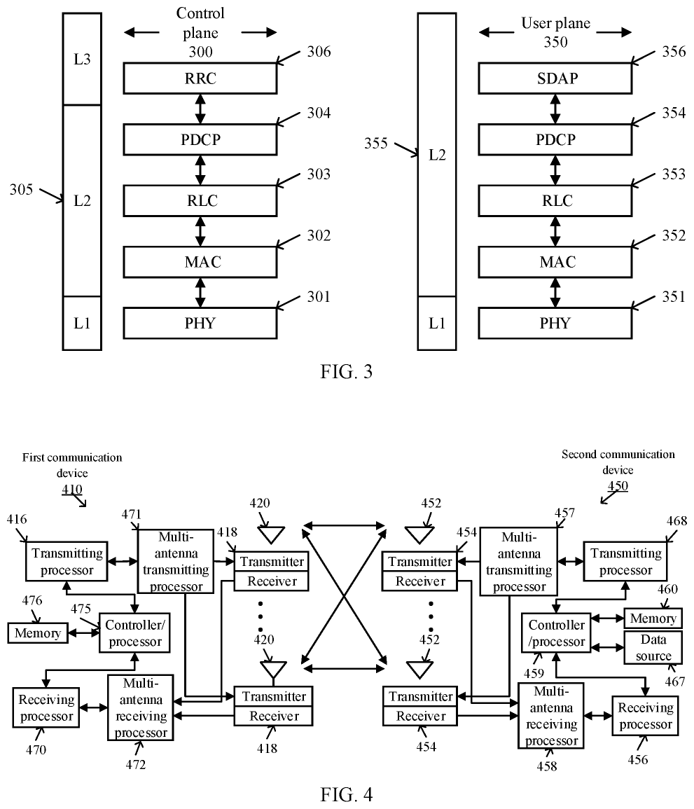

Embodiment 3 illustrates a schematic diagram of an example of a radio protocol architecture of a user plane and a control plane according to the present application, as shown in FIG. 3.

FIG. 3 is a schematic diagram illustrating an embodiment of a radio protocol architecture of a user plane 350 and a control plane 300. In FIG. 3, the radio protocol architecture for a control plane 300 between a first communication node (UE, or Road Side Unit/RSU in Vehicle to Everything (V2X), vehicle-mounted equipment or vehicle-mounted communication module) and a second node (gNB, UE, or RSU in V2X, vehicle-mounted equipment or vehicle-mounted communication module), or between two UEs is represented by three layers, i.e., a layer 1, a layer 2 and a layer 3, respectively. The layer 1 (L1) is the lowest layer which performs signal processing functions of various PHY layers. The L1 is called PHY 301 in the present application. The layer 2 (L2) 305 is above the PHY 301, and is in charge of the link between the first node and the second node or between two UEs via the PHY 301. The L2 305 comprises a Medium Access Control (MAC) sublayer 302, a Radio Link Control (RLC) sublayer 303 and a Packet Data Convergence Protocol (PDCP) sublayer 304. All the three sublayers terminate at the second nodes. The PDCP sublayer 304 provides multiplexing among variable radio bearers and logical channels. The PDCP sublayer 304 provides security by encrypting a packet and provides support for handover of a first communication node between second communication nodes. The RLC sublayer 303 provides segmentation and reassembling of a higher-layer packet, retransmission of a lost packet, and reordering of a packet so as to compensate the disordered receiving caused by Hybrid Automatic Repeat reQuest (HARQ). The MAC sublayer 302 provides multiplexing between a logical channel and a transport channel. The MAC sublayer 302 is also responsible for allocating between first communication nodes various radio resources (i.e., resource block) in a cell. The MAC sublayer 302 is also in charge of HARQ operation. In the control plane 300, the RRC sublayer 306 in the L3 is responsible for acquiring radio resources (i.e., radio bearer) and configuring the lower layer using an RRC signaling between the second communication node and the first communication node. The radio protocol architecture in the user plane 350 comprises the L1 layer and the L2 layer. In the user plane 350, the radio protocol architecture used for the first communication node and the second communication node in a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 layer 355 in the user plane 350 also comprises a Service Data Adaptation Protocol (SDAP) sublayer 356, which is in charge of the mapping between QoS streams and a Data Radio Bearer (DRB), so as to support diversified traffics. Although not described in FIG. 3, the first communication node may comprise several higher layers above the L2 355, such as a network layer (i.e., IP layer) terminated at a P-GW 213 of the network side and an application layer terminated at the other side of the connection (i.e., a peer UE, a server, etc.).

In one embodiment, the radio protocol architecture in FIG. 3 is applicable to the first node in the present application.

In one embodiment, the radio protocol architecture in FIG. 3 is applicable to the transmitter of a PDCCH in the present application.

In one embodiment, the first message is generated by the RRC sublayer 306 and the MAC sublayer 302.

In one embodiment, the first signaling is generated by the PHY 301, or the PHY 351.

In one embodiment, the higher layer in the present application refers to a layer above the PHY layer.

In one embodiment, the lower layer in the present application refers to a layer below the MAC layer.

### Embodiment 4

Embodiment 4 illustrates a schematic diagram of a first communication device and a second communication device according to one embodiment of the present application, as shown in FIG. 4. FIG. 4 is a block diagram of a first communication device 410 and a second communication device 450 in communication with each other in an access network.

The first communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

The second communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

In a transmission from the first communication device 410 to the second communication device 450, at the first communication device 410, a higher layer packet from a core network is provided to the controller/processor 475. The controller/processor 475 provides functions of the L2 layer. In DL, the controller/processor 475 provides header compression, encryption, packet segmentation and reordering, multiplexing between a logical channel and a transport channel and radio resource allocation of the second communication device 450 based on various priorities. The controller/processor 475 is responsible for HARQ operation, retransmission of a lost packet and a signaling to the second communication device 450. The transmitting processor 416 and the multi-antenna transmitting processor 471 perform various signal processing functions used for the L1 layer (i.e., PHY). The transmitting processor 416 performs coding and interleaving so as to ensure a Forward Error Correction (FEC) at the second communication device 450 and the mapping of signal clusters corresponding to each modulation scheme (i.e., Binary Phase Shift Keying (BPSK), Quadrature Phase Shift Keying (QPSK), M-PSK, and M-Quadrature Amplitude Modulation (M-QAM), etc.). The multi-antenna transmitting processor 471 performs digital spatial precoding, which includes precoding based on codebook and precoding based on non-codebook, and beamforming processing on encoded and modulated signals to generate one or more parallel streams. The transmitting processor 416 then maps each parallel stream to a subcarrier. The modulated symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream, which is later provided to different antennas 420.

In a transmission from the first communication device 410 to the second communication device 450, at the second communication device 450, each receiver 454 receives a signal via a corresponding antenna. Each receiver 454 recovers information modulated to the RF carrier, and converts the radio frequency stream into a baseband multicarrier symbol stream to be provided to the receiving processor 456. The receiving processor 456 and the multi-antenna receiving processor 458 provide various signal processing functions of the L1. The multi-antenna receiving processor 458 performs reception analog precoding/beamforming on a baseband multicarrier symbol stream provided by the receiver 454. The receiving processor 456 converts the processed baseband multicarrier symbol stream from time domain into frequency domain using Fast Fourier Transform (FFT). In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any second communication device 450-targeted parallel stream. Symbols on each parallel stream are demodulated and recovered in the receiving processor 456 to generate a soft decision. Then the receiving processor 456 decodes and de-interleaves the soft decision to recover the higher-layer data and control signal transmitted by the first communication device 410 on the physical channel. Next, the higher-layer data and control signal are provided to the controller/processor 459. The controller/processor 459 provides functions of the L2. The controller/processor 459 can be associated with a memory 460 that stores program code and data. The memory 460 can be called a computer readable medium. In DL transmission, the controller/processor 459 provides de-multiplexing between a transport channel and a logical channel, packet reassembling, decryption, header decompression, control signal processing so as to recover a higher-layer packet from the core network. The higher-layer packet is later provided to all protocol layers above the L2. Or various control signals can be provided to the L3 for processing. The controller/processor 459 also performs error detection using Acknowledgement (ACK) and/or Negative Acknowledgement (NACK) protocols as a way to support HARQ operation.

In a transmission from the second communication device 450 to the first communication device 410, at the second communication device 450, the data source 467 is used to provide a higher layer packet to the controller/processor 459. The data source 467 represents all protocol layers above the L2. Similar to a transmitting function of the first communication device 410 described in DL, the controller/processor 459 performs header compression, encryption, packet segmentation and reordering, and multiplexing between a logical channel and a transport channel based on radio resource allocation for the first communication device 410 so as to provide the L2 functions used for the user plane and the control plane. The controller/processor 459 is responsible for HARQ operation, retransmission of a lost packet and a signaling to the first communication device 410. The transmitting processor 468 performs modulation and mapping, as well as channel coding, and the multi-antenna transmitting processor 457 performs digital multi-antenna spatial precoding, including codebook-based precoding and non-codebook-based precoding, and beamforming. The transmitting processor 468 then modulates generated parallel streams into multicarrier/single-carrier symbol streams. The modulated symbol streams, after being subjected to analog precoding/beamforming in the multi-antenna transmitting processor 457, are provided from the transmitter 454 to each antenna 452. Each transmitter 454 firstly converts a baseband symbol stream provided by the multi-antenna transmitting processor 457 into a radio frequency symbol stream, and then provides the symbol stream to the antenna 452.

In a transmission from the second communication device 450 to the first communication device 410, the function of the first communication device 410 is similar to the receiving function of the second communication device 450 described in the transmission from the first communication device 410 to the second communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and the multi-antenna receiving processor 472 jointly provide functions of the L1. The controller/processor 475 provides functions of the L2. The controller/processor 475 can be associated with the memory 476 that stores program code and data. The memory 476 can be called a computer readable medium. The controller/processor 475 provides demultiplexing between a transport channel and a logical channel, packet reassembling, decryption, header decompression and control signal processing so as to recover a higher-layer packet from the second communication device 450. The higher-layer packet coming from the controller/processor 475 may be provided to the core network. The controller/processor 475 can also perform error detection using ACK and/or NACK protocol to support HARQ operation.

In one embodiment, the second communication device 450 comprises at least one processor and at least one memory, the at least one memory comprises computer program codes; the at least one memory and the computer program codes are configured to be used in collaboration with the at least one processor. The second communication device 450 at least maintains a first timer; as a response to expiration of the first timer, starts to monitor a PDCCH on at least second Bandwidth Part (BWP); a first BWP is an active BWP, the first timer depending on the first BWP; while the second BWP is a BWP on a first serving cell other than a default BWP, where the first BWP and the second BWP are both on the first serving cell; the action of maintaining a first timer comprises: as a response to any condition in a first condition set being satisfied, starting or restarting the first timer; the first condition set includes receiving a PDCCH on the first BWP, the PDCCH being used for a Downlink assignment or Uplink Grant, and the PDCCH being identified by a first identifier; the default BWP on the first serving cell is indicated by a defaultDownlinkBWP-Id or an initialDownlinkBWP.

In one embodiment, the second communication device 450 comprises a memory that stores a computer readable instruction program, the computer readable instruction program generates actions when executed by at least one processor, which include: maintaining a first timer; and starting to monitor a PDCCH on at least second BWP.

In one embodiment, the first communication device 410 comprises at least one processor and at least one memory, the at least one memory comprises computer program codes; the at least one memory and the computer program codes are configured to be used in collaboration with the at least one processor. The first communication device 410 at least transmits a first signaling; the first signaling indicates second BWP, the first signaling being non-UE dedicated.

In one embodiment, the first communication device 410 comprises a memory that stores a computer readable instruction program, the computer readable instruction program generates actions when executed by at least one processor, which include: transmitting a first signaling.

In one embodiment, the first node in the present application comprises the second communication device 450.

In one embodiment, the second node in the present application comprises the first communication device 410.

In one embodiment, at least one of the antenna 452, the receiver 454, the receiving processor 456, the multi-antenna receiving processor 458, the controller/processor 459, the memory 460 or the data source 467 is used for maintaining the first timer.

In one embodiment, at least one of the antenna 452, the receiver 454, the receiving processor 456, the multi-antenna receiving processor 458, the controller/processor 459, the memory 460 or the data source 467 is used for starting to monitor a PDCCH on the second BWP.

In one embodiment, at least one of the antenna 420, the transmitter 418, the transmitting processor 416, the multi-antenna transmitting processor 471, the controller/processor 475 or the memory 476 is used for transmitting the first signaling.

### Embodiment 5

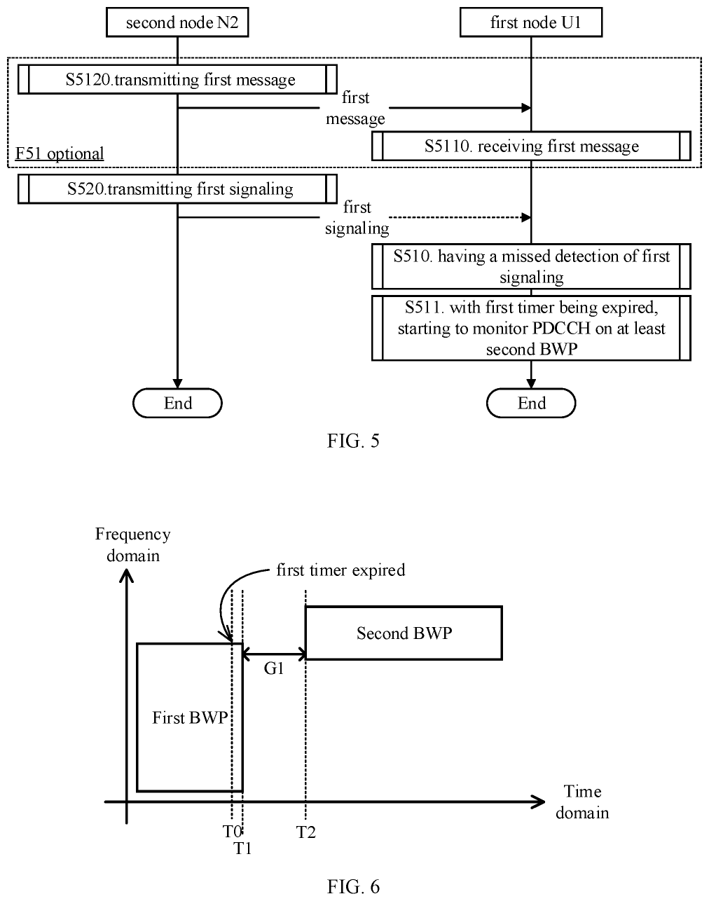

Embodiment 5 illustrates a first flowchart of transmission between a first node and a second node according to one embodiment of the present application. In FIG. 5, a first node U1 and a second node N2 are in communication via a radio link, where the steps marked by the box 51 are optional. It should be particularly noted that the sequence illustrated herein does not set any limit to the signal transmission order or implementation order in the present application.

The first node U1 receives a first message in step S5110; and has a missed detection of a first signaling in step S510, and in step S511, a first timer is expired, and as a response to the expiration of the first timer, the first node U1 starts to monitor a PDCCH on at least second BWP.

The second node N2 transmits a first message in step S5120; and transmits a first signaling in step S520.

In Embodiment 5, a first BWP is an active BWP, the first timer depending on the first BWP, while the second BWP is a BWP on a first serving cell other than a default BWP, where the first BWP and the second BWP are both on the first serving cell; the action of maintaining a first timer comprises: as a response to any condition in a first condition set being satisfied, starting or restarting the first timer; the first condition set includes receiving a PDCCH on the first BWP, the PDCCH being used for a Downlink assignment or Uplink Grant, and the PDCCH being identified by a first identifier; the default BWP on the first serving cell is indicated by a defaultDownlinkBWP-Id or an initialDownlinkBWP.

In one embodiment, the first node U1 is the first node in the present application.

In one embodiment, the second node N2 is the second node in the present application.

In one embodiment, the second node is a base station.

In one embodiment, the second node is a UE.

In one embodiment, the second node is a relay node.

In one embodiment, an air interface between the second node N2 and the first node U1 includes a radio interface between a base station and a UE.

In one embodiment, an air interface between the second node N2 and the first node U1 includes a radio interface between a relay node and a UE.

In one embodiment, an air interface between the second node N2 and the first node U1 includes a radio interface between a UE and another UE.

In one embodiment, steps marked by the box 51 do not exist.

In one embodiment, steps marked by the box 51 exist, the first node in the present application receiving a first message.

In one embodiment, the first BWP is the default BWP on the first serving cell, the first message being used to trigger or enable a start or restart of the first timer when the first BWP is an active BWP.

In one embodiment, the first message is transmitted via an air interface or a radio interface.

In one embodiment, the first message is transmitted via a higher layer signaling or a physical layer signaling.

In one embodiment, the first message is a higher layer signaling.

In one embodiment, the first information block is carried by a MAC CE signaling.

In one embodiment, the first message is an RRC layer signaling.

In one embodiment, the first message comprises a physical layer signaling.

In one embodiment, the first message comprises a dynamically configured signaling.

In one embodiment, the first message comprises information in all or part of fields in a DCI.

In one embodiment, the first message comprises at least one RRC Information element (IE).

In one embodiment, the first message comprises information in all or part of fields in an RRC IE.

In one embodiment, the first message is an RRC IE.

In one embodiment, the first message is carried by an RRC IE.

In one embodiment, the first message comprises information in all or part of fields in a System Information Block (SIB).

In one embodiment, the first message comprises information in all or part of fields in a ServingCellConfigCommonSIB IE.

In one embodiment, the first message comprises information in all or part of fields in a DownlinkConfigCommonSIB IE.

In one embodiment, the first message comprises information in all or part of fields in a BWP-DownlinkCommon IE.

In one embodiment, the first message comprises information in all or part of fields in a BWP IE.

In one embodiment, the first message is used for configuring the second BWP.

In one embodiment, the first message is used to determine the second BWP.

In one embodiment, the first message is used to determine a bandwidth of the second BWP.

In one embodiment, the first message is used to indicate a bandwidth of the second BWP.

In one embodiment, the first message is used to indicate a Subcarrier spacing (SCS) configuration of the second BWP.

In one embodiment, the first message is used to indicate a Cyclic prefix (CP) configuration of the second BWP.

In one embodiment, the first message is non-UE dedicated.

In one embodiment, the first message is a cell-specific signaling.

In one embodiment, the first message is a UE-group common signaling.

In one embodiment, the first message is transmitted on a Physical downlink shared channel (PDSCH).

In one embodiment, the first message is transmitted on a Physical broadband channel (PBCH).

In one embodiment, the first message is transmitted on a PDCCH.

### Embodiment 6

Embodiment 6 illustrates a schematic diagram of the first BWP being the default BWP of the first serving cell according to one embodiment of the present application, as shown in FIG. 6. In FIG. 6, the first BWP is default BWP on the first serving cell, the first timer expires at a time TO, and as a response to the expiration of the first timer, the first node, starting from a time T1 and after being through a time G1, monitors a PDCCH on the second BWP at a time T2; the G1 is equal to the T2 being subtracted by the T1.

In one embodiment, the first timer expires at a time TO.

In one embodiment, the T1 is a time of the first node after expiration of the first timer.

In one embodiment, the T1 is a first slot in a subframe of the first node immediately after expiration of the first timer.

In one embodiment, the T1 is a first slot in a half subframe of the first node immediately after expiration of the first timer.

In one embodiment, G1 depends on UE capability.

In one embodiment, G1 comprises a positive integer number of slot(s).

In one embodiment, G1 depends on a bwp-SwitchingDelay.

In one embodiment, G1 depends on SCS configurations of the first BWP and the second BWP.

In one embodiment, G1 depends on SCS configuration of a smaller one of the first BWP and the second BWP.

In one embodiment, the first node is not required to transmit an uplink signal or receive a downlink signal within the G1 duration.

In one embodiment, G1 refers to a BWP switching delay, of which the specific definition can be found in 3GPP TS 38.133 V17.6.0, Section 8.6.

In one embodiment, the first BWP is on a first serving cell.

In one embodiment, the first BWP is the default BWP on the first serving cell.

In one embodiment, the first BWP is indicated by a defaultDownlinkBWP-Id.

In one embodiment, the first BWP is indicated by an initialDownlinkBWP.

In one embodiment, the first BWP is indicated by a defaultDownlinkBWP-Id or initialDownlinkBWP.

In one embodiment, a BWP-Id of the first BWP is equal to the defaultDownlinkBWP-Id.

In one embodiment, a BWP-Id of the first BWP is equal to 0.

In one embodiment, the first BWP is an Initial BWP.

In one embodiment, the sentence that the first BWP is indicated by the defaultDownlinkBWP-Id or initialDownlinkBWP includes a meaning that: when the first node is configured with a defaultDownlinkBWP-Id for the first serving cell, the first BWP is indicated by the defaultDownlinkBWP-Id.

In one embodiment, the sentence that the first BWP is indicated by the defaultDownlinkBWP-Id or initialDownlinkBWP includes a meaning that: when the first node is configured without a defaultDownlinkBWP-Id for the first serving cell, the first BWP is indicated by an initialDownlinkBWP.

In one embodiment, the sentence that the first BWP is indicated by the defaultDownlinkBWP-Id or initialDownlinkBWP includes a meaning that: when the first node is configured with a defaultDownlinkBWP-Id for the first serving cell, a BWP-Id of the first BWP is equal to the defaultDownlinkBWP-Id.

In one embodiment, the sentence that the first BWP is indicated by the defaultDownlinkBWP-Id or initialDownlinkBWP includes a meaning that: when the first node is configured without a defaultDownlinkBWP-Id for the first serving cell, a “BWP-Id” of the first BWP is equal to 0.

In one embodiment, the at least second BWP includes/include only the second BWP.

In one embodiment, as a response to expiration of the first timer, the first node in the present application starts to monitor a PDCCH on the second BWP.

In one embodiment, when the first timer is expired, the first node in the present application starts to monitor a PDCCH on the second BWP.

In one embodiment, expiration of the first timer is used to determine that the first node in the present application starts to monitor a PDCCH on the second BWP.

In one embodiment, expiration of the first timer is a triggering condition for that the first node in the present application starts to monitor a PDCCH on the second BWP.

In one embodiment, as a response to expiration of the first timer, the first node in the present application stops monitoring a PDCCH on the first BWP.

In one embodiment, as a response to expiration of the first timer, the first node in the present application stops monitoring a PDCCH on the first BWP and starts to monitor a PDCCH on the second BWP.

In one embodiment, the first node starts to monitor a PDCCH on the second BWP at a time T2.

In one embodiment, the meaning of the sentence of starting to monitor a PDCCH on second BWP includes: resuming PDCCH monitoring according to a Search space set on the second BWP.

In one embodiment, the meaning of the sentence of starting to monitor a PDCCH on second BWP includes: monitoring a PDCCH according to a search space set with a group index 0 on the second BWP.

In one embodiment, the first condition set comprises: receiving a PDCCH on the default BWP on the first serving cell, the PDCCH being used for a Downlink assignment or Uplink Grant, and the PDCCH being identified by the first identifier.

In one embodiment, the first condition set comprises: receiving a PDCCH on the default BWP on the first serving cell, the PDCCH being used for a Downlink assignment or Uplink Grant, and the PDCCH being identified by the first identifier.

In one embodiment, the first condition set comprises: receiving a PDCCH on the default BWP on the first serving cell, the PDCCH being used for a Downlink assignment or Uplink Grant, and the PDCCH being identified by a first identifier.

### Embodiment 7

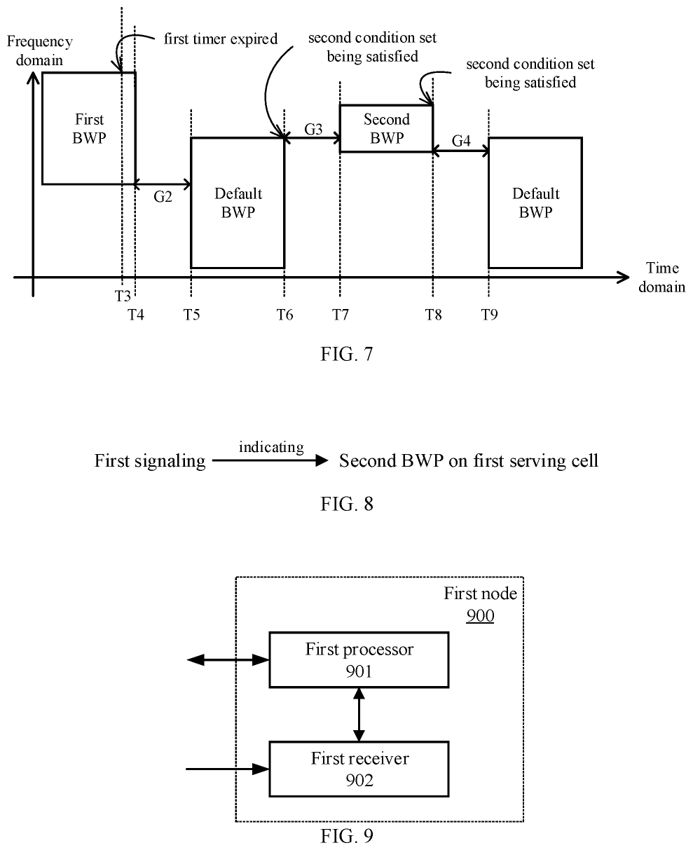

Embodiment 7 illustrates a schematic diagram of at least second BWP including default BWP of the first serving cell according to one embodiment of the present application, as shown in FIG. 7. In FIG. 7, the at least second BWP includes/include the default BWP on the first serving cell, and the first timer expires at a time T3, as a response to the expiration of the first timer, starting from a time T4 and after being through a time G2, start to monitor a PDCCH on the default BWP on the first serving cell at a time T5; the G2 is equal to the T5 being subtracted by the T4;

In Embodiment 7, starting from the time T5, the first node monitors a PDCCH on the default BWP on the first serving cell, and any condition in a second condition set is satisfied at a time T6, as a response to any condition in the second condition set being satisfied, the first node, starting from the time T6 and after being through a time G3, starts to monitor a PDCCH on the second BWP at a time T7, where G3 is equal to the T7 being subtracted by the T6.

In Embodiment 7, starting from the time T7, the first node monitors a PDCCH on the second BWP, and any condition in a second condition set is satisfied at a time T8, as a response to any condition in the second condition set being satisfied, the first node, starting from the time T8 and after being through a time G4, starts to monitor a PDCCH on the default BWP on the first serving cell at a time T9, where G4 is equal to the T9 being subtracted by the T8.

In Embodiment 7, the first node is Time Division Duplexing (TDD) on the second BWP and the default BWP on the first serving cell.

In one embodiment, the first timer expires at a time T3.

In one embodiment, the T4 is a time of the first node after expiration of the first timer.

In one embodiment, the T4 is a first slot in a subframe of the first node immediately after expiration of the first timer.

In one embodiment, the T4 is a first slot in a half subframe of the first node immediately after expiration of the first timer.

In one embodiment, G2 depends on UE capability.

In one embodiment, G2 comprises a positive integer number of slot(s).

In one embodiment, G2 depends on a bwp-SwitchingDelay.

In one embodiment, G2 depends on SCS configurations of the first BWP and the second BWP.

In one embodiment, G2 depends on SCS configuration of a smaller one of the first BWP and the second BWP.

In one embodiment, the first node is not required to transmit an uplink signal or receive a downlink signal within the G2 duration.

In one embodiment, G2 refers to a BWP switching delay, of which the specific definition can be found in 3GPP TS 38.133 V17.6.0, Section 8.6.

In one embodiment, G3 depends on UE capability.

In one embodiment, G3 comprises a positive integer number of slot(s).

In one embodiment, G3 depends on a bwp-SwitchingDelay.

In one embodiment, G3 depends on SCS configurations of the first BWP and the second BWP.

In one embodiment, G3 depends on SCS configuration of a smaller one of the first BWP and the second BWP.

In one embodiment, the first node is not required to transmit an uplink signal or receive a downlink signal within the G3 duration.

In one embodiment, G3 refers to a BWP switching delay, of which the specific definition can be found in 3GPP TS 38.133 V17.6.0, Section 8.6.

In one embodiment, G3 is smaller than a BWP switching delay.

In one embodiment, G3 is equal to G2.

In one embodiment, G3 is unequal to G2.

In one embodiment, G4 depends on UE capability.

In one embodiment, G4 comprises a positive integer number of slot(s).

In one embodiment, G4 depends on a bwp-SwitchingDelay.

In one embodiment, G4 depends on SCS configurations of the first BWP and the second BWP.

In one embodiment, G4 depends on SCS configuration of a smaller one of the first BWP and the second BWP.

In one embodiment, the first node is not required to transmit an uplink signal or receive a downlink signal within the G4 duration.

In one embodiment, G4 refers to a BWP switching delay, of which the specific definition can be found in 3GPP TS 38.133 V17.6.0, Section 8.6.

In one embodiment, G4 is smaller than a BWP switching delay.

In one embodiment, G4 is equal to G2.

In one embodiment, G4 is unequal to G2.

In one embodiment, G4 is equal to G3.

In one embodiment, G4 is unequal to G3.

In one embodiment, G2, G3 and G4 are mutually equal.

In one embodiment, G2, G3 and G4 are unequal respectively.

In one embodiment, the time T6 and the time T8 are respectively configured by RRC signaling.

In one embodiment, the time T6 and the time T8 are respectively configurable.

In one embodiment, the time T6 and the time T8 are respectively pre-configured.

In one embodiment, values obtained by subtracting the time T5 from the time T6 and subtracting the time T7 from the time T8 are respectively configured by RRC signaling.

In one embodiment, values obtained by subtracting the time T5 from the time T6 and subtracting the time T7 from the time T8 are respectively configurable.

In one embodiment, values obtained by subtracting the time T5 from the time T6 and subtracting the time T7 from the time T8 are respectively pre-configured.

In one embodiment, values obtained by subtracting the time T5 from the time T6 and subtracting the time T7 from the time T8 are respectively fixed.

In one embodiment, each of values obtained by subtracting the time T5 from the time T6 and subtracting the time T7 from the time T8 respectively comprises a positive integer number of millisecond(s) (ms).

In one embodiment, each of values obtained by subtracting the time T5 from the time T6 and subtracting the time T7 from the time T8 respectively comprises a positive integer number of slot(s).

In one embodiment, each of values obtained by subtracting the time T5 from the time T6 and subtracting the time T7 from the time T8 respectively comprises a positive integer number of subframe(s).

In one embodiment, each of values obtained by subtracting the time T5 from the time T6 and subtracting the time T7 from the time T8 respectively comprises a positive integer number of symbol(s).

In one subembodiment, the symbol includes an Orthogonal Frequency Division Multiplexing (OFDM) Symbol.

In one subembodiment, the symbol includes a Discrete Fourier Transform Spread OFDM (DFT-S-OFDM) symbol.

In one subembodiment, the symbol is obtained by an output by transform precoding through OFDM Symbol Generation.

In one embodiment, when the first node monitors a PDCCH on a BWP of the at least second BWP, and as a response to receiving the PDCCH, the first node stops monitoring a PDCCH on any BWP of the at least second BWP other than the BWP.

In one embodiment, the first BWP is not the default BWP on the first serving cell.

In one embodiment, the first BWP is not indicated by a defaultDownlinkBWP-Id.

In one embodiment, the first BWP is not indicated by an initialDownlinkBWP.

In one embodiment, the first BWP is not indicated by a defaultDownlinkBWP-Id or initialDownlinkBWP.

In one embodiment, a “BWP-Id” of the first BWP is unequal to the defaultDownlinkBWP-Id.

In one embodiment, a “BWP-Id” of the first BWP is unequal to 0.

In one embodiment, a “BWP-Id” of the first BWP is equal to a positive integer.

In one embodiment, the first BWP is not an initial BWP.

In one embodiment, the sentence that the first BWP is not indicated by the defaultDownlinkBWP-Id or initialDownlinkBWP includes a meaning that: when the first node is configured with a defaultDownlinkBWP-Id in the first serving cell, the first BWP is not indicated by the defaultDownlinkBWP-Id.

In one embodiment, the sentence that the first BWP is not indicated by the defaultDownlinkBWP-Id or initialDownlinkBWP includes a meaning that: when the first node is configured without a defaultDownlinkBWP-Id in the first serving cell, the first BWP is not indicated by an initialDownlinkBWP.

In one embodiment, the sentence that the first BWP is not indicated by the defaultDownlinkBWP-Id or initialDownlinkBWP includes a meaning that: when the first node is configured with a defaultDownlinkBWP-Id in the first serving cell, a BWP-Id of the first BWP is unequal to the defaultDownlinkBWP-Id.

In one embodiment, the sentence that the first BWP is not indicated by the defaultDownlinkBWP-Id or initialDownlinkBWP includes a meaning that: when the first node is configured without a defaultDownlinkBWP-Id in the first serving cell, a “BWP-Id” of the first BWP is unequal to 0.

In one embodiment, the sentence that the first BWP is not indicated by the defaultDownlinkBWP-Id or initialDownlinkBWP includes a meaning that: when the first node is configured without a defaultDownlinkBWP-Id in the first serving cell, a “BWP-Id” of the first BWP is equal to a positive integer.

In one embodiment, the at least second BWP includes/include the default BWP on the first serving cell.

In one embodiment, each of the at least second BWP is a DL BWP.

In one embodiment, as a response to expiration of the first timer, the first node in the present application stops monitoring a PDCCH on the first BWP.

In one embodiment, as a response to expiration of the first timer, the first node in the present application stops monitoring a PDCCH on the first BWP and starts to monitor a PDCCH on the at least second BWP.

In one embodiment, the meaning of the sentence of starting to monitor a PDCCH on at least second BWP includes: starting to resume PDCCH monitoring on a Search space set on the at least second BWP.

In one embodiment, the meaning of the sentence of starting to monitor a PDCCH on at least second BWP includes: starting to monitor a PDCCH according to a search space set with a group index 0 on the at least second BWP.

In one embodiment, the meaning of the sentence of starting to monitor a PDCCH on at least second BWP includes: starting to resume PDCCH monitoring according to a Search space set on the second BWP.

In one embodiment, the meaning of the sentence of starting to monitor a PDCCH on at least second BWP includes: starting to monitor a PDCCH according to a search space set with a group index 0 on the second BWP.

In one embodiment, the meaning of the sentence of starting to monitor a PDCCH on at least second BWP includes: starting to resume PDCCH monitoring according to a Search space set on the default BWP on the first serving cell.

In one embodiment, the meaning of the sentence of starting to monitor a PDCCH on at least second BWP includes: starting to monitor a PDCCH according to a search space set with a group index 0 on the default BWP on the first serving cell.

In one embodiment, the meaning of the sentence of starting to monitor a PDCCH on at least second BWP includes: starting to monitor a PDCCH on the second BWP, or, starting to monitor a PDCCH on the default BWP on the first serving cell.

In one embodiment, the meaning of the sentence of starting to monitor a PDCCH on at least second BWP includes: starting to resume PDCCH monitoring according to a Search space set on the second BWP, or starting to resume PDCCH monitoring according to a search space set on the default BWP on the first serving cell.

In one embodiment, the meaning of the sentence of starting to monitor a PDCCH on at least second BWP includes: starting to resume PDCCH monitoring according to a Search space set on the second BWP, or starting to monitor a PDCCH according to a search space set with a group index 0 on the default BWP on the first serving cell.

In one embodiment, the meaning of the sentence of starting to monitor a PDCCH on at least second BWP includes: starting to monitor a PDCCH according to a Search space set with a group index 0 on the second BWP, or starting to resume PDCCH monitoring according to a search space set on the default BWP on the first serving cell.

In one embodiment, the meaning of the sentence of starting to monitor a PDCCH on at least second BWP includes: starting to monitor a PDCCH according to a Search space set with a group index 0 on the second BWP, or starting to monitor a PDCCH according to a search space set with a group index 0 on the default BWP on the first serving cell.

In one embodiment, the meaning of the sentence of starting to monitor a PDCCH on at least second BWP includes: monitoring a PDCCH on the default BWP on the first serving cell and monitoring a PDCCH on the second BWP being TDD.

In one embodiment, the meaning of the sentence of starting to monitor a PDCCH on at least second BWP includes: monitoring a PDCCH in a Time division duplexing (TDD) manner on the default BWP on the first serving cell and on the second BWP.

In one embodiment, the meaning of the sentence of starting to monitor a PDCCH on at least second BWP includes: monitoring a PDCCH according to a search space set with a group index 0 on the default BWP on the first serving cell and resuming PDCCH monitoring according to a Search space set on the second BWP being TDD.

In one embodiment, the meaning of the sentence of starting to monitor a PDCCH on at least second BWP includes: resuming PDCCH monitoring according to a Search space set on the default BWP on the first serving cell and monitoring a PDCCH according to a search space set with a group index 0 on the second BWP being TDD.

In one embodiment, the meaning of the sentence of starting to monitor a PDCCH on at least second BWP includes: resuming PDCCH monitoring according to a Search space set on the default BWP on the first serving cell and resuming PDCCH monitoring according to a Search space set on the second BWP being TDD.

In one embodiment, the meaning of the sentence of starting to monitor a PDCCH on at least second BWP includes: monitoring a PDCCH according to a search space set with a group index 0 on the default BWP on the first serving cell and monitoring a PDCCH according to a search space set with a group index 0 on the second BWP being TDD.

In one embodiment, the meaning of the sentence of starting to monitor a PDCCH on at least second BWP includes: as a response to expiration of the first timer, the first node firstly starts to monitor a PDCCH on the default BWP on the first serving cell, and when any condition in the second condition set is satisfied, as a response to any condition in the second condition set being satisfied, the first node starts to monitor a PDCCH on the second BWP.

In one embodiment, the meaning of the sentence of starting to monitor a PDCCH on at least second BWP includes: as a response to expiration of the first timer, the first node firstly starts to monitor a PDCCH on the second BWP, and when any condition in the second condition set is satisfied, as a response to any condition in the second condition set being satisfied, the first node starts to monitor a PDCCH on the default BWP on the first serving cell.

In one embodiment, the second condition set comprises that the first timer is expired, the first timer depending on an active DL BWP.

In one embodiment, the second condition set comprises a first slot in a subframe immediately after expiration of the first timer, the first timer depending on an active DL BWP.

In one embodiment, the second condition set comprises a first slot in a half subframe immediately after expiration of the first timer, the first timer depending on an active DL BWP.

In one embodiment, the second condition set comprises: the first node monitoring a PDCCH on the default BWP on the first serving cell, the first timer depending on the default BWP on the first serving cell, the first timer being expired.

In one embodiment, the second condition set comprises: the first node monitoring a PDCCH on the second BWP, the first timer depending on the second BWP, the first timer being expired.

In one embodiment, the second condition set comprises: the first node monitoring a PDCCH on the default BWP on the first serving cell, the first timer depending on the default BWP on the first serving cell, and a first slot in a subframe immediately after expiration of the first timer.

In one embodiment, the second condition set comprises: the first node monitoring a PDCCH on the default BWP on the first serving cell, the first timer depending on the default BWP on the first serving cell, and a first slot in a half subframe immediately after expiration of the first timer.

In one embodiment, the second condition set comprises: the first node monitoring a PDCCH on the second BWP, the first timer depending on the second BWP, and a first slot in a subframe immediately after expiration of the first timer.

In one embodiment, the second condition set comprises: the first node monitoring a PDCCH on the second BWP, the first timer depending on the second BWP, and a first slot in a half subframe immediately after expiration of the first timer.

In one embodiment, the second condition set does not comprise the first condition set.

In one embodiment, the first condition set does not comprise the second condition set.

In one embodiment, any condition in the second condition set does not belong to the first condition set.

In one embodiment, any condition in the first condition set does not belong to the second condition set.

### Embodiment 8

Embodiment 8 illustrates a schematic diagram of a first signaling being used to determine second BWP according to one embodiment of the present application, as shown in FIG. 8.

In one embodiment, the first signaling is dynamically configured.

In one embodiment, the first signaling comprises a layer 1 (L1) signaling.

In one embodiment, the first signaling comprises a layer 1 (L1) control signaling.

In one embodiment, the first signaling comprises a Physical Layer signaling.

In one embodiment, the first signaling comprises one or more fields in a physical layer signaling.

In one embodiment, the first signaling comprises a Higher Layer signaling.

In one embodiment, the first signaling comprises one or more fields in a Higher Layer signaling.

In one embodiment, the first signaling comprises an RRC signaling.

In one embodiment, the first signaling comprises a MAC CE signaling.

In one embodiment, the first signaling comprises one or more fields in an RRC signaling.

In one embodiment, the first signaling comprises one or more fields in a MAC CE signaling.

In one embodiment, the first signaling is an RRC signaling.

In one embodiment, the first signaling is a MAC CE signaling.

In one embodiment, the first signaling comprises DCI.

In one embodiment, the first signaling comprises information in one or more fields in a DCI.

In one embodiment, a CRC of the first signaling is scrambled by a G-RNTI.

In one embodiment, a CRC of the first signaling is scrambled by a G-CS-RNTI.

In one embodiment, a CRC of the first signaling is scrambled by a MCCH-RNTI.

In one embodiment, the first signaling is a DCI.

In one embodiment, the first signaling is a field in a DCI.

In one embodiment, the first signaling comprises Sidelink Control Information (SCI).

In one embodiment, the first signaling comprises one or more fields in an SCI.

In one embodiment, the first signaling comprises one or more fields in an Information Element (IE).

In one embodiment, the first signaling is a DownLink assignment signaling.

In one embodiment, the first signaling is an UpLink grant signaling.

In one embodiment, the first signaling is transmitted in a downlink physical layer control channel (i.e., a downlink channel only capable of bearing physical layer signaling).

In one embodiment, a format of the first signaling is one of format 0_1, format 0_2, format 1_1 or format 1_2.

In one embodiment, a format of the first signaling is a format other than format 0_1, format 0_2, format 1_1 and format 1_2.

In one embodiment, the first signaling is used for scheduling at least one Physical downlink shared channel (PDSCH).

In one embodiment, the first signaling is used for scheduling at least one Physical uplink shared channel (PUSCH).

In one embodiment, the first signaling implicitly indicates second BWP.

In one embodiment, the first signaling explicitly indicates a BWP-Id of second BWP.

In one embodiment, the first signaling is used to determine a “BWP-Id” of the second BWP.

In one embodiment, the first signaling indicates a “BWP-Id” of the second BWP.

In one embodiment, the first signaling comprises a DCI, where a DCI field in the first signaling is used to determine the second BWP.

In one embodiment, the first signaling comprises a DCI, where a DCI field in the first signaling is used to indicate the second BWP.

In one embodiment, the first signaling comprises a DCI, where a DCI field in the first signaling comprises one bit, the one bit indicating a “BWP-Id” of the second BWP.

In one embodiment, the first signaling comprises a DCI, where a DCI field in the first signaling comprises two bits, the two bits indicating a “BWP-Id” of the second BWP.

In one embodiment, a “BWP-Id” of the second BWP is equal to a value of one DCI field in the first signaling plus 1.

In one embodiment, a “BWP-Id” of the second BWP is equal to a value of one DCI field in the first signaling.

In one embodiment, the first signaling comprises a DCI, where a DCI field in the first signaling comprises one bit, the one bit indicating whether to switch to the second BWP.

In one embodiment, the first signaling is non-UE dedicated.

In one embodiment, the first signaling is a cell-specific signaling.

In one embodiment, the first signaling is a UE-group common signaling.

In one embodiment, the first signaling is transmitted on a PDCCH.

In one embodiment, the first signaling is transmitted on a PDSCH.

### Embodiment 9

Embodiment 9 illustrates a structure block diagram of a processing device used in a first node according to one embodiment of the present application, as shown in FIG. 9. In FIG. 9, a processing device 900 in a first node comprises a first processor 901 and a first receiver 902.

In Embodiment 9, the first processor 901 maintains a first timer; and starts to monitor a PDCCH on at least second BWP; the first receiver 902 receives a first message.

In one embodiment, the first processor 901 maintains a first timer; and as a response to expiration of the first timer, starts to monitor a PDCCH on at least second Bandwidth Part (BWP). A first BWP is an active BWP, the first timer depending on the first BWP, while the second BWP is a BWP on a first serving cell other than a default BWP, where the first BWP and the second BWP are both on the first serving cell; the action of maintaining a first timer comprises: as a response to any condition in a first condition set being satisfied, starting or restarting the first timer; the first condition set includes receiving a PDCCH on the first BWP, the PDCCH being used for a Downlink assignment or Uplink Grant, and the PDCCH being identified by a first identifier; the default BWP on the first serving cell is indicated by a defaultDownlinkBWP-Id or an initialDownlinkBWP.

In one embodiment, as a response to expiration of the first timer, the first node stops monitoring a PDCCH on the first BWP.

In one embodiment, the first BWP is the default BWP on the first serving cell.

In one subembodiment, when the first node is configured without a defaultDownlinkBWP-Id in the first serving cell, the first BWP is indicated by an initialDownlinkBWP.

In one subembodiment, when the first node is configured with a defaultDownlinkBWP-Id in the first serving cell, a BWP-Id of the first BWP is equal to the defaultDownlinkBWP-Id.

In one subembodiment, as a response to expiration of the first timer, the first node resumes PDCCH monitoring according to a search space set on the second BWP.

In one subembodiment, as a response to expiration of the first timer, the first node monitors a PDCCH on a search space set with a group index 0 on the second BWP.

In one embodiment, the at least second BWP includes/include the default BWP on the first serving cell.

In one embodiment, the first processor 901 monitors a PDCCH on a BWP of the at least second BWP, and as a response to receiving the PDCCH, stops monitoring a PDCCH on any BWP of the at least second BWP other than the BWP.

In one embodiment, the first receiver receives a first message; the first message is used for configuring the second BWP.

In one embodiment, the processing device 900 in the first node has a missed detection of a first signaling, the first signaling indicating the second BWP, the first signaling being non-UE dedicated.

In one embodiment, as a response to expiration of the first timer, the first node starts to monitor a PDCCH on the second BWP, or starts to monitor a PDCCH on the default BWP on the first serving cell.

In one embodiment, as a response to expiration of the first timer, monitoring a PDCCH on the default BWP on the first serving cell and monitoring a PDCCH on the second BWP are TDD.

In one embodiment, the first node is a UE.

In one embodiment, the first node is a relay node.

In one embodiment, the first receiver 901 comprises at least one of the antenna 452, the receiver 454, the receiving processor 456, the multi-antenna receiving processor 458, the controller/processor 459, the memory 460 or the data source 467 in Embodiment 4.

In one embodiment, the first processor 902 comprises at least one of the antenna 452, the receiver 454, the receiving processor 456, the multi-antenna receiving processor 458, the transmitter 454, the transmitting processor 468, the multi-antenna transmitting processor 457, the controller/processor 459, the memory 460 or the data source 467 in Embodiment 4.

The ordinary skill in the art may understand that all or part of steps in the above method may be implemented by instructing related hardware through a program. The program may be stored in a computer readable storage medium, for example Read-Only-Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present application is not limited to any combination of hardware and software in specific forms. The UE and terminal in the present application include but are not limited to unmanned aerial vehicles, communication modules on unmanned aerial vehicles, telecontrolled aircrafts, aircrafts, diminutive airplanes, mobile phones, tablet computers, notebooks, vehicle-mounted communication equipment, vehicles, automobiles, RSU, wireless sensor, network cards, terminals for Internet of Things (IOT), Radio Frequency Identification (RFID) terminals, Narrow Band Internet of Things (NB-IOT) terminals, Machine Type Communication (MTC) terminals, enhanced MTC (eMTC) terminals, data cards, low-cost mobile phones, low-cost tablet computers, etc. The base station or system device in the present application includes but is not limited to macro-cellular base stations, micro-cellular base stations, home base stations, relay base station, evolved Node B/eNB, gNB, Transmitter Receiver Point (TRP), Global Navigation Satellite System (GNSS), relay satellite, satellite base station, airborne base station, Road Side Unit (RSU), drones, test equipment like transceiving device simulating partial functions of base station or signaling tester.

It will be appreciated by those skilled in the art that this disclosure can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, characterized in comprising:
a first processor, maintaining a first timer; and as a response to expiration of the first timer, starting to monitor a PDCCH on at least second Bandwidth Part (BWP);
wherein a first BWP is an active BWP, the first timer depending on the first BWP, while the second BWP is a BWP on a first serving cell other than a default BWP, where the first BWP and the second BWP are both on the first serving cell; the action of maintaining a first timer includes: as a response to any condition in a first condition set being satisfied, starting or restarting the first timer; the first condition set includes receiving a PDCCH on the first BWP, the PDCCH being used for a Downlink assignment or Uplink Grant, and the PDCCH being identified by a first identifier; the default BWP on the first serving cell is indicated by a defaultDownlinkBWP-Id or an initialDownlinkBWP.

2. The first node according to claim 1, characterized in that the first BWP is the default BWP on the first serving cell.

3. The first node according to claim 1, characterized in that the at least second BWP includes/include the default BWP on the first serving cell.

4. The first node according to claim 1, characterized in comprising:
the first processor, monitoring a PDCCH on a BWP of the at least second BWP, and as a response to receiving the PDCCH, stopping monitoring a PDCCH on any BWP of the at least second BWP other than the BWP.

5. The first node according to claim 1, characterized in comprising:
a first receiver, receiving a first message;
wherein the first message is used for configuring the second BWP.

6. The first node according to claim 1, characterized in that the first node has a missed detection of a first signaling, the first signaling indicating the second BWP, the first signaling being non-UE dedicated.

7. The first node according to claim 1, characterized in that a bandwidth of the second BWP is smaller than the first BWP.

8. The first node according to claim 1, characterized in that the first condition set comprises: receiving a MAC Protocol Data Unit (PDU) in a configured Downlink assignment for unicast or MBS multicast.

9. The first node according to claim 1, characterized in that the first condition set comprises: transmitting a MAC PDU in an Uplink Grant, and not receiving an indication of LBT failure from lower layers.

10. The first node according to claim 1, characterized in that the first BWP is a BWP on the first serving cell other than the default BWP and an initial BWP.

11. The first node according to claim 1, characterized in that the at least second BWP includes/include a BWP other than the second BWP, and the at least second BWP includes/include the default BWP on the first serving cell.

12. The first node according to claim 1, characterized in that the sentence of starting to monitor a PDCCH on at least second BWP includes a meaning as follows: monitoring a PDCCH on the default BWP and the second BWP on the first serving cell in TDD manner.

13. A method in a first node for wireless communications, characterized in comprising:
maintaining a first timer; and as a response to expiration of the first timer, starting to monitor a PDCCH on at least second Bandwidth Part (BWP);
wherein a first BWP is an active BWP, the first timer depending on the first BWP, while the second BWP is a BWP on a first serving cell other than a default BWP, where the first BWP and the second BWP are both on the first serving cell; the action of maintaining a first timer includes: as a response to any condition in a first condition set being satisfied, starting or restarting the first timer; the first condition set includes receiving a PDCCH on the first BWP, the PDCCH being used for a Downlink assignment or Uplink Grant, and the PDCCH being identified by a first identifier; the default BWP on the first serving cell is indicated by a defaultDownlinkBWP-Id or an initialDownlinkBWP.

14. The method in the first node according to claim 13, characterized in that the first BWP is the default BWP on the first serving cell.

15. The method in the first node according to claim 13, characterized in that the at least second BWP includes/include the default BWP on the first serving cell.

16. The method in the first node according to claim 13, characterized in comprising:
monitoring a PDCCH on a BWP of the at least second BWP, and as a response to receiving the PDCCH, stopping monitoring a PDCCH on any BWP of the at least second BWP other than the BWP.

17. The method in the first node according to claim 13, characterized in comprising:
receiving a first message;
wherein the first message is used for configuring the second BWP.

18. The method in the first node according to claim 13, characterized in that the first node has a missed detection of a first signaling, the first signaling indicating the second BW, the first signaling being non-UE dedicated.

19. The method in the first node according to claim 13, characterized in that a bandwidth of the second BWP is smaller than the first BWP.

20. The method in the first node according to claim 13, characterized in that the first condition set comprises: receiving a MAC PDU in a configured Downlink assignment for unicast or MBS multicast.
